(19) United States
(12) Patent Application Publication
(10) Pub. No.: US 2013/0167347 A1
(43) Pub. Date: Jul. 4, 2013

(54) RETROFIT RAMP SYSTEM FOR A BATHING TUB

(71) Applicant: Roger R. Gardner, Entiat, WA (US)

(72) Inventor: Roger R. Gardner, Entiat, WA (US)

(21) Appl. No.: 13/341,764

(22) Filed: Dec. 30, 2011

(51) Int. Cl. B23P 17/04

(52) U.S. Cl. 29/401.1

(57) ABSTRACT

A retrofit ramp system for a bathing tub, including end-caps at each end of a removed portion or notch in a bathtub or shower sidewall, the notch sized for receiving a retrofit ramp. The ramp is inserted into the notch, covering a base potion of the notch and providing a smooth transition from the tub floor to an external floor. The ramp includes a threshold plate adjoined to an incline plate, with a grooved seal to join the ramp to the tub floor, forming a watertight connection. The ramp is fabricated from a non-skid material and includes a calking applied within the grooved seal. The retrofit ramp system is easily packaged in a kit that is usable for most exiting bathtubs and showers. The retrofit ramp system provides easy access for persons with limited mobility, or with wheelchairs or walkers.

### TECHNICAL FIELD

A retrofit ramp system, and specifically a system for retro-fitting a bathtub or shower tray with a wheelchair accessible ramp. The system includes a durable, high impact, mildew resistant and machine-able plastic ramp, with a grove extending horizontally along the interior length of the ramp. The grove mates onto the existing tub floor of the shower tray or bath tub for a sturdy, watertight and permanent connection.

### BACKGROUND OF THE INVENTION

For people with disabilities, bathtubs are often difficult, if not impossible, to enter and exit. Doors, rails and steps are well-known solutions to easing access to bathtubs and curbed showers.

However, new installations that require the demolition and removal of existing showers or bathtubs are expensive and labor intensive. Additionally, the replacement, ‘handicap accessible’ types of bathtubs or showers are often very expensive and complex to operate. A simplified, ‘kit’ bathtub retrofit system is needed that efficiently modifies existing tub and shower installations, to provide a water retaining bathing system with easy access for persons with limited mobility, or with wheelchairs or walkers.

The following is a disclosure of the present invention that will be understood by reference to the following detailed description taken in conjunction with the accompanying drawings.

### BRIEF DESCRIPTION OF DRAWINGS

FIG. 1 is a perspective view of a retrofit ramp system, according to an embodiment of the invention;

FIG. 2 is a sectioned side view of a portion of a retrofit ramp system, according to an embodiment of the invention;

FIG. 3 is a sectioned side view of a portion of a retrofit ramp system, according to an embodiment of the invention;

FIG. 4 is a sectioned side view of a retrofit ramp system, according to an embodiment of the invention;

FIG. 4A is a sectioned side view of a detail portion of the retrofit ramp system shown in FIG. 4, according to an embodiment of the invention;

FIG. 5 is a front view of a retrofit ramp system, according to an embodiment of the invention; and

FIG. 6 is a top view of a retrofit ramp system, according to an embodiment of the invention.

Reference characters included in the above drawings indicate corresponding parts throughout the several views, as discussed herein. The description herein illustrates one preferred embodiment of the invention, in one form, and the description herein is not to be construed as limiting the scope of the invention in any manner. It should be understood that the above listed figures are not necessarily to scale and that the embodiments are sometimes illustrated by fragmentary views, graphic symbols, diagrammatic or schematic representations, and phantom lines. Details that are not necessary for an understanding of the present invention by one skilled in the technology of the invention, or render other details difficult to perceive, may have been omitted.

### DETAILED DESCRIPTION OF SPECIFIC EMBODIMENTS

The invention provides a system for retro-fitting a ramp to a bathing tub with a wheelchair accessible type of ramp. The system of the present invention it may be employed to retrofit almost any bathing type of tub, bathtub, shower, or similar functioning enclosure that collects or holds water for personal bathing purposes. These types of bathing enclosures or ‘tubs’ are referred to herein generally as bathtubs, or as a bathtub in a singular reference.

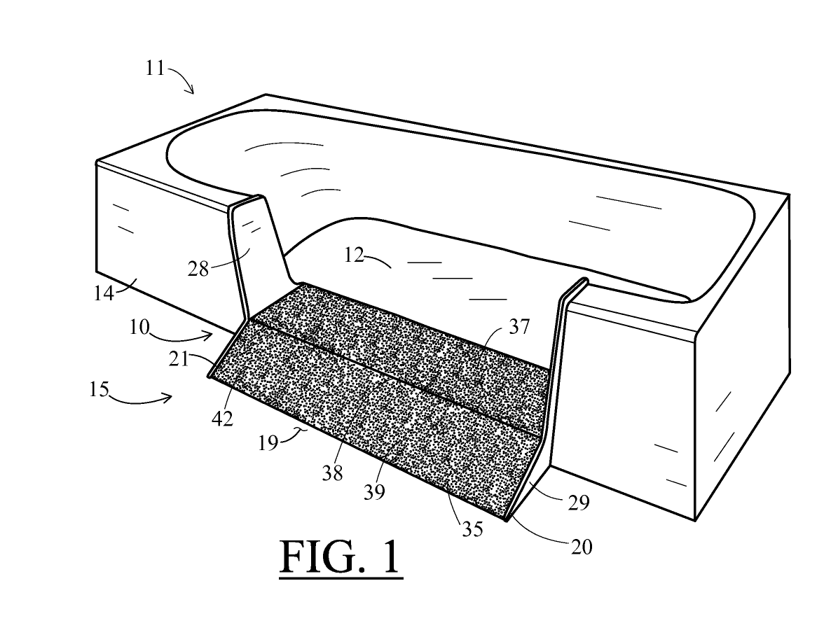

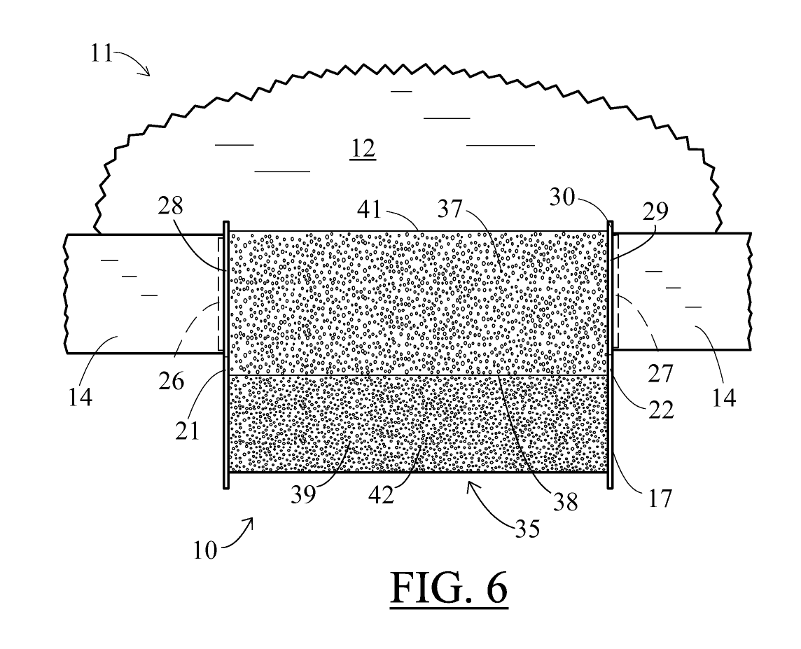

A preferred embodiment of a retrofit ramp system 10 is shown in FIGS. 1 through 6. As shown in FIG. 1, the retrofit ramp system is installed into bathtub 11. Conventionally, the bathtub or tub includes a tub floor 12, surrounded by a side-wall 14. As is typical, the bathtub may be fabricated out of a metal, a fiberglass material, an enamel or ceramic coated metal, or a plastic. Surprisingly, cast iron bathtubs can also be retrofit with the ramp system of the present invention. Additionally, the bathtub can contain wood components, often employed as supports and framing, and typically found within the interior portions of certain types of bathtubs and shower enclosures.

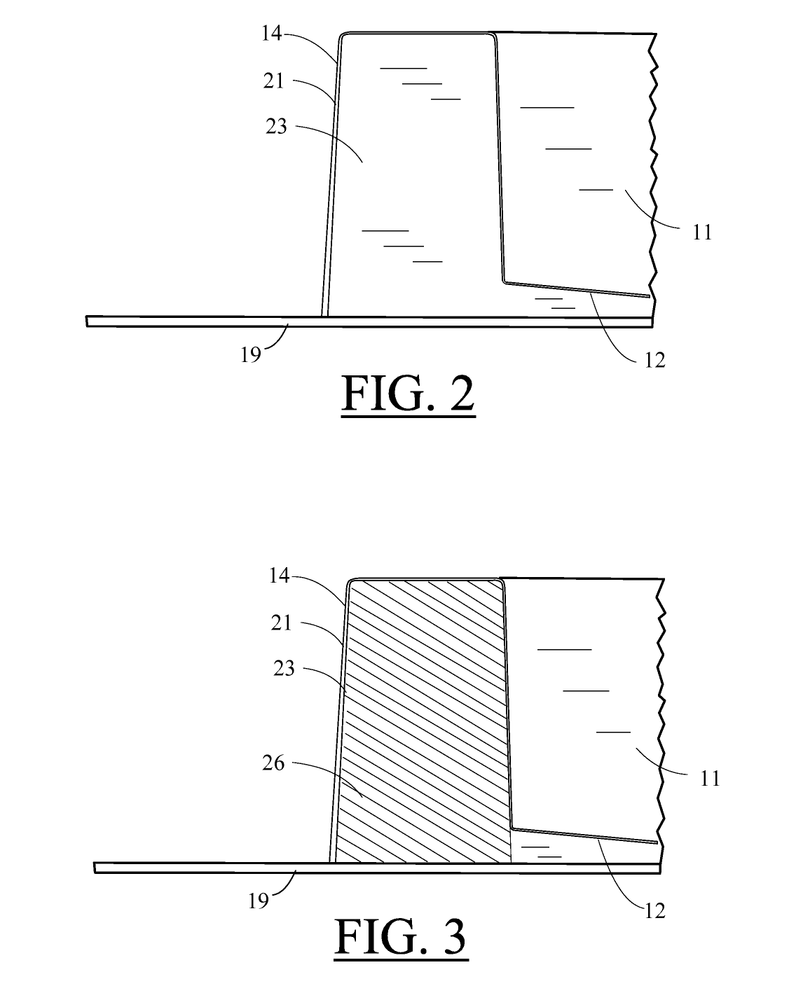

Specifically, the retrofit ramp system 10 of the present invention is installed into a notch 15, that is cut into the sidewall 14, which is preferably a sidewall of an existing bathtub 11, as shown in FIG. 1. The notch in the bathtub that receives the retrofit ramp system is detailed in FIGS. 2, 3 and 4. Again, the bathtub may be any conventional tub, shower stall or enclosure having the surrounding side-wall, which can also be described as a curb or lip. The side-wall functions to contain or retain water in the bathtub or shower, as well known to those persons knowledgeable or skilled in the design and installation of bathing tubs and related devices.

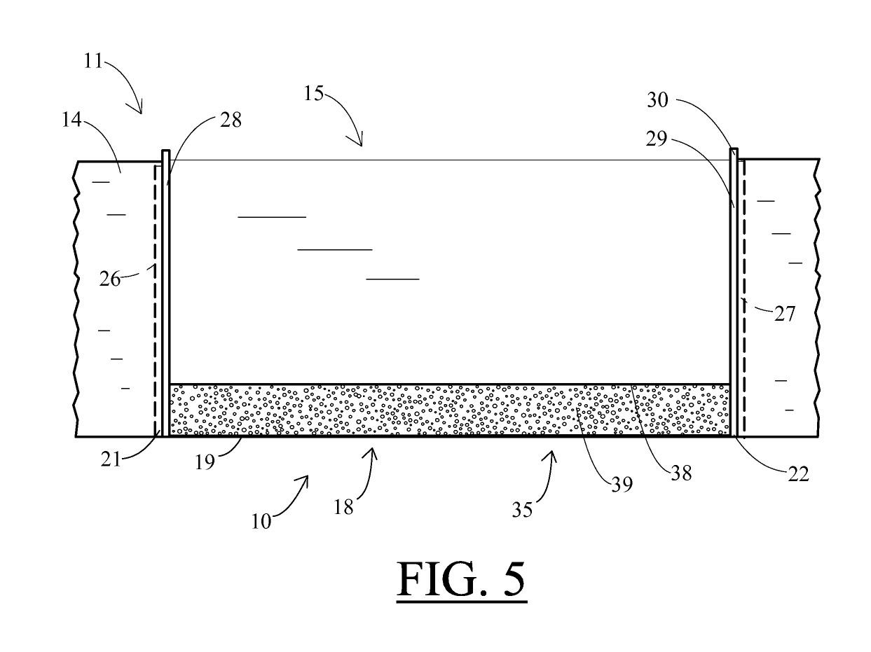

The notch 15 is formed by removing a portion of the sidewall 14 from the bathtub 11. A Sawzall™ or similar device can be used for typical fiberglass bathtubs, and a conventional grinder with a diamond type masonry or metal cutting blade can be used for metal and clad or coated metal bathtubs. As shown in FIGS. 1 and 5, the notch includes a base portion 18, which is positioned substantially parallel to an external floor 19, between a first end 21 of the notch that is separated from and opposite a second end 22 of the notch. The notch is sized for receiving the retrofit ramp system 10, and is preferably approximately thirty-three inches or wider, from the first end to the second end of the notch. This width is preferred to accommodate wheel chairs and walkers, but can be longer or shorter, depending on the particular needs or requirements for any specific installation of the retrofit ramp system.

The terms “approximately” or “approximate” are employed herein throughout, including this detailed description and the attached claims, with the understanding that the terms denotes a level of exactness as typical for the skill and precision in the generally applicable field of technology.

Creating the notch 15, typically forms openings within the sidewall 14 of the bathtub 11. As shown in FIG. 2, a first sidewall opening 23 appears at the first end 21 of the notch, and a second sidewall opening 24 appears at the second end 22 of the notch. Most preferably, plugs can be inserted into the voids within the sidewalls, to best cap these openings in the bathtub. As shown in FIG. 3, a first plug 26 is placed within the first sidewall opening, and a second plug 27 is placed within the first sidewall opening. The first and second plugs can be fabricated from plywood and custom shaped to fit within the first and second sidewall opening, respectively.

After plugging the sidewall 14 of the bathtub 11 with the first plug 26 at the first sidewall opening 23, and the second plug 27 at the second sidewall opening 24, a first end-cap 28 is placed over and affixed to the first plug 26 at the first end 21 of the notch 15. Likewise, a second end-cap 29 is placed over and affixed to the second plug 27 at the second end 22 of the notch. FIGS. 1, 4, and 6 show the first and second end-caps as slightly prominent or oversized, as most preferred, to create an end-cap lip 30 at each sidewall opening.

A ramp 35 can now be inserted into the notch 15, between the first end-cap 28 and the second end-cap 29. The ramp covers the base potion 18 of the notch, as shown in FIG. 5, while also providing a stable surface and a smooth transition between the tub floor 12 and the external floor 19, which is exterior to the bathtub 11. As shown in FIGS. 1, 4, 5 and 6, the ramp including a threshold plate 37 and an incline plate 39. The ramp may be made of any water proof material with the strength required to support users of the retrofit ramp system 10. Preferably, the threshold plate and an incline plate are formed from a single piece of material that is bent along a break-line 38. Most preferably, the ramp is formed from a high-density, marine grade of polyethylene, and is approximately between one-half and three-quarters of an inch in thickness. When made of the preferred polyethylene material, the ramp is durable, highly impact resistant, mildew resistant and machine-able. When made from the preferred polyethylene, the ramp can be heated in an oven to render the material flexible, and then bent along the break-line, to form the angles in the material as needed for the incline plate and the threshold plate. Additionally, the preferred polyethylene is also warm to the feet of the user of the installed ramp system. However, other conventional materials could be employed for use in fabricating the ramp.

Most preferably, as shown in FIG. 1, the ramp 35 includes a non-skid surface tread 42 that preferably includes dimples, or alternatively ribs formed on or in the ramp approximately parallel to the base portion 18 of the notch 15. Standard diamond patterns, grooves or any conventionally known and typical traction features may be added onto or milled into the ramp. Additionally, each installation of the retrofit ramp system 10 can be custom fit in consideration of the size of the subject bathroom, and accommodating any particular bathtub 11 in size, shape, style and construction.

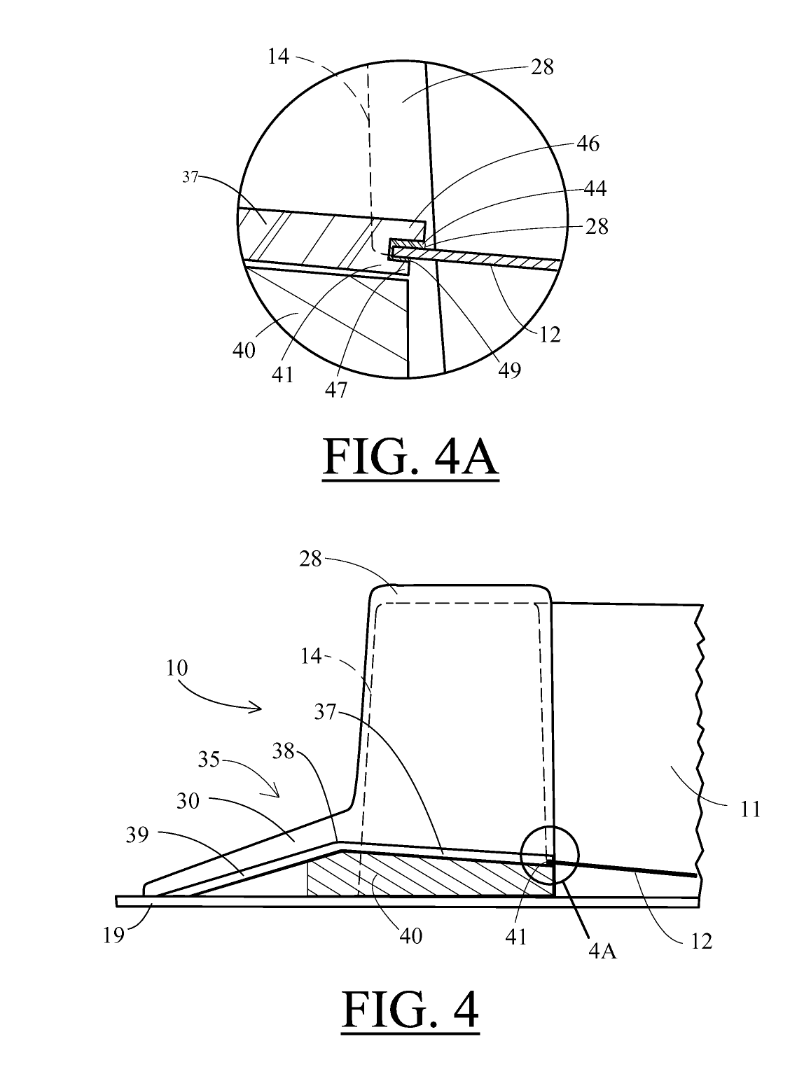

Typically, bathtubs and shower stalls with special features for the disabled, and bathtubs with user access bars and aids can be preserved with the present invention. Preferably, as shown in FIG. 4, the threshold plate 37 of the ramp 35 is adjacent to the incline plate 39. Along the break-line. As discussed above, the threshold plate and the incline plate are formed from a single, bent piece of material. Alternatively, the threshold plate and the incline plate may be fabricated from two adjoined pieces of material, or be any multiple of joined sections and still serve the required purpose of providing a smooth and strong transition between the tub floor 12 and the eternal floor 19.

As shown in FIG. 4, a ramp support 40 is preferably installed beneath the ramp 35. Most preferably, the ramp support is a wooden shim, sized to fill any gap between the ramp and the external floor 19. The ramp support anchors the ramp and prevents flex or movement of the ramp.

As detailed In FIG. 4, the threshold plate 37 has a leading edge 41, which is located on the length of the threshold plate that spans from the first end 21 of the notch 15 to the second end 22 of the notch, and opposite to side of the threshold plat that adjoins the incline plate 39. The leading edge includes a grooved seal 44, as detailed in FIG. 4A. The grooved seal includes a slot 45 that is milled or otherwise cut into the leading edge of the threshold plate. Preferably, the grooved seal also includes an upper lip 46 and a lower lip 47, with the tub floor 12 received into the grooved seal, along the length of the leading edge of the threshold plate.

Most preferably the grooved seal 44 is offset, as shown in FIG. 4A, with the upper lip 46 extending further from the threshold plate 37 than the lower lip 47, to provide secure support and coverage of the tub floor 12, which is received into the slot 45 of the grooved seal. As also shown in FIG. 4A, a calking 49 is preferably applied within the slot of the grooved seal, to permanently join and interlock the threshold plate with the tub floor. By securely joining the grooved seal of the threshold plate to the tub floor, a remarkably permanent and watertight connection forms between the threshold plate and the tub floor.

The drainage of water across the threshold plate is a key consideration and an advantage with the retrofit ramp system 10 of the present invention. The desired drainage is accomplished by slightly sloping the threshold plate 37 toward the tub floor 12, as shown in FIG. 4, so that water on the threshold plate runs back into the bathtub 11, instead of out of the bathtub and down the incline plate 39, to the external floor 19.

Another advantage of the retrofit ramp system 10 is that with the notch 15 removed from the sidewall 14 of the bathtub 11, the usable floor area bathtub or shower is increased significantly. Typically, the floor area of the bathtub is increased by approximately thirty percent, with installation of the retrofit ramp system. Additionally, the retrofit ramp system provides structural reenforcement to the existing tub floor 12, and with the easier entry and exit to the bathtub the retrofit is much safer than climbing over the sidewall 14. Most significantly, the retrofit ramp system is able to comply with the egress specifications for wheelchairs, under the American Disabilities Act of 1990.

The retrofit ramp system 10 can be easily packaged in a simplified kit that is usable for most exiting bathtubs and showers. The retrofit ramp system of the present invention efficiently modifies existing tub and shower installations, to provide a water retaining bathing system with easy access for persons with limited mobility, or with wheelchairs or walkers.

In compliance with the statutes, the invention has been described in language more or less specific as to structural features and process steps. While this invention is susceptible to embodiments in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents.

The following is claimed:

1. A method for a retrofit ramp system to a bathing type of tub, the method essentially comprising the steps of:
a) removing a portion of a sidewall from the tub to create a notch, the tub including a tub floor, the notch including a base portion, the base portion substantially between and separating a first end of the notch opposite from a second end of the notch, and the notch sized for receiving the retrofit ramp system;
b) capping a first sidewall opening at the first end of the notch with a first end-cap;
c) capping a second sidewall opening at the second end of the notch with a second end-cap;
d) inserting a ramp into the notch between the first end cap and the second end-cap, the ramp for covering the base potion of the notch and providing a smooth transition from the tub floor to an external floor, the ramp including a threshold plate and an incline plate, the threshold plate having a leading edge opposite the ramp, the leading edge including a grooved seal, and the incline plate substantially flush with the external floor;
e) joining the grooved seal of the threshold plate to the tub floor; and
f) forming a watertight connection between the threshold plate and the tub floor.

2. The method for a retrofit ramp system to a bathing type of tub of claim 1, additionally including the step of:
g) fabricating the ramp from a non-skid material.

3. The method for a retrofit ramp system to a bathing type of tub of claim 1, additionally including the step of:
g) setting a ramp support beneath the ramp.

4. The method for a retrofit ramp system to a bathing type of tub of claim 1, additionally including the step of:
g) applying a calk within the slot of the grooved seal.

5. The method for a retrofit ramp system to a bathing type of tub of claim 1, additionally including the step of:
g) installing a first plug within the first sidewall opening at the first end of the notch in the sidewall of the bathtub; and
h) installing a second plug within the second sidewall opening at the second end of the notch in the sidewall of the bathtub.

6. A method for a retrofit ramp system to a bathing type of tub, the method essentially comprising the steps of:
a) creating a notch in the tub, the notch formed in a portion of a sidewall of the tub, the notch including a base portion, the base portion substantially between and separating a first end of the notch opposite from a second end of the notch, and the notch sized for receiving the retrofit ramp system;
b) capping a first sidewall opening at the first end of the notch with a first end-cap;
c) capping a second sidewall opening at the second end of the notch with a second end-cap;
d) inserting a ramp into the notch between the first end cap and the second end-cap, the tub including a tub floor, the ramp for covering the base potion of the notch and providing a smooth transition from the tub floor to an external floor outside the tub, the ramp including a threshold plate and an incline plate, the threshold plate having a leading edge opposite the ramp, the leading edge including a grooved seal, and the incline plate substantially flush with the external floor;
e) joining the grooved seal of the threshold plate to the tub floor; and
f) forming a watertight connection between the threshold plate and the tub floor.

7. The method for the installation of a retrofit ramp system to a bathing type of tub of claim 6, additionally including the step of:
g) fabricating the ramp from a non-skid material.

8. The method for the installation of a retrofit ramp system to a bathing type of tub of claim 6, additionally including the step of:
g) setting a ramp support beneath the ramp.

9. The method for the installation of a retrofit ramp system to a bathing type of tub of claim 6, additionally including the step of:
g) applying a calk within the slot of the grooved seal.

10. The method for the installation of a retrofit ramp system to a bathing type of tub of claim 6, additionally including the step of:
g) installing a first plug within the first sidewall opening at the first end of the notch in the sidewall of the bathtub; and
h) installing a second plug within the second sidewall opening at the second end of the notch in the sidewall of the bathtub.
